(19) United States
(12) Patent Application Publication
(10) Pub. No.: US 2026/0210362 A1
(43) Pub. Date: Jul. 23, 2026

(54) VORTEX SLURRY PUMP

(71) Applicant: Thomas Stuart MILLER, George (ZA)

(72) Inventor: Thomas Stuart MILLER, George (ZA)

(21) Appl. No.: 19/456,213

(22) Filed: Jan. 22, 2026

(30) Foreign Application Priority Data
Jan. 22, 2025 (ZA) 2025/00704

(51) Int. Cl. F04D 7/04; B01F 25/60; F04D 29/043; F04D 29/049; F04D 29/08

(52) U.S. Cl. CPC F04D 7/045; B01F 25/60; F04D 29/043; F04D 29/049; F04D 29/086

(57) ABSTRACT

A vortex slurry pump is provided comprising a column having a drive end and a wet end; a cantilever pump shaft rotatably supported within the column, and a drive means operatively connected to the drive end of the pump shaft. A vortex impeller is mounted to the wet end of the pump shaft, the impeller being configured to operate submerged in a slurry. At least one bearing arrangement is disposed within the column to support the cantilever pump shaft. An expeller seal arrangement is disposed between the vortex impeller and the at least one bearing arrangement, the expeller seal arrangement being configured to generate a dynamic seal to prevent the slurry from entering the column and contacting the at least one bearing arrangement.

### CROSS-REFERENCE TO RELATED APPLICATIONS

The present application claims the priority benefit of South African Patent Application No. 2025/00704 filed 22 Jan. 2025, incorporated by reference in its entirety herein.

### FIELD OF THE INVENTION

This invention relates to a vortex slurry pump for use in various slurry applications. One such application relates to the pumping of slurries with large particles, in which it is imperative that these large particles do not directly contact an impeller of the pump.

### BACKGROUND OF THE INVENTION

Vortex slurry pumps are designed to handle both clean and dirty water containing soft and hard solids in suspension. They are often used for applications such as sewage dewatering, wastewater management, and slurry dewatering. These pumps are also used to effectively manage the flow of materials, such as mill scale, settled sludge, and coal, gold, platinum and copper slurry.

These pumps are manufactured in various sizes to suit different industrial needs, typically ranging from 2 inches (50 mm) to 12 inches (300 mm) in discharge diameter.

In one version, a typical vortex slurry pump takes the form of a vertical spindle pump, comprising:

### 1. Bearing Column

This component is a key feature of vertical spindle pumps. The bearing column typically protrudes out of the slurry fluid and includes bearings to support a pump shaft or spindle that is connected to a mechanical driving mechanism, such as an electric or diesel motor.

### 2. Pump Shaft/Spindle

The pump shaft or spindle, which is typically vertically arranged in use, is accommodated within the bearing column. An upper end of the pump shaft is driven by the motor via a coupling, and the lower end is fitted with a vortex impeller, agitator or inducer, submerged within the slurry fluid or media in use.

### 3. Impeller

The impeller is the rotating component that moves and agitates the slurry fluid or media. In vertical spindle pumps, the impeller is arranged to operate vertically, and is often designed to handle higher solids content, such as in slurry applications.

### 4. Impeller Casing

The impeller casing encloses the impeller and is typically made from wear resistant and corrosive resistant materials to withstand abrasive and corrosive slurries.

Conventional vertical spindle pumps have several shortcomings, including:
Limited Depth Capability: Vertical spindle pumps are typically limited by the length of the bearing column, which restricts the depth to which they can be submerged. This can be a disadvantage in applications requiring deeper sump operations.
Vibration and Stability: These pumps can experience vibration and stability issues, particularly when operating at high speeds or with long shafts. This can lead to increased wear and potential mechanical failures.
Maintenance: Maintenance can be challenging, especially in harsh environments where access is difficult.
Material Wear: Despite being constructed from wear and corrosive resistant materials, the constant exposure to abrasive and corrosive slurries can lead to material degradation over time, necessitating frequent inspections and replacements.

The objective of the present invention is to provide a vortex slurry pump that addresses at least some of the above shortcomings. In particular, the aim is to provide a vortex slurry pump that can be used in either a horizontal or vertical configuration, and that uses a hydraulic wet end design to provide ease of maintenance and longevity by keeping contaminants out of the bearings of the bearing column.

### SUMMARY OF THE INVENTION

According to the invention, there is provided a vortex slurry pump to pump a slurry fluid or media, the vortex slurry pump comprising:
a column, the operative upper end of which can support a (mechanical) drive means (such as an electric motor) via a coupling arrangement (or pulleys or belts), the column in use operating above the slurry fluid or media;
a pump shaft accommodated within the column, an upper end of the pump shaft being connected to the drive means, and a lower end of the pump shaft being fitted with an impeller to define a hydraulic wet end, with the impeller being submerged within the slurry fluid in use and being arranged to agitate large concentrations of solids within the slurry fluid and keep them in suspension to prevent impeller blockage;
a first bearing arrangement to facilitate the rotation of the pump shaft relative to the column; and
an expeller self-flushing seal (SFS) arrangement in the form of a hydro dynamic pressurised expeller (HDPE) SFS adjacent the first bearing arrangement, to prevent contaminants passing therethrough.

The drive means may be a direct drive motor or, alternatively, a belt-driven arrangement wherein a motor is mounted adjacent to the column and connected via a pulley and belt system.

The vortex slurry pump can be operated either vertically or horizontally.

In a further aspect of the invention, the first bearing arrangement and a second bearing arrangement are configured to support a cantilevered pump shaft. The bearing arrangement at the wet end, or non-drive end (NDE), comprises at least one angular contact ball bearing, and preferably two, accurately spaced to accommodate shaft flex and cantilever loads. The bearing arrangement at the drive end (DE) comprises a roller bearing. This configuration provides robust support while simplifying on-site maintenance by eliminating the need for critical end play adjustments associated with other bearing types, such as taper roller bearings.

In an embodiment, the column comprises:
an operatively upper bearing barrel, the operatively lower end of which is fitted with the expeller self-flushing seal (SFS) arrangement; and
an operatively lower extension column,
   the operatively lower end of the upper bearing barrel and the operatively upper end of the lower extension column comprising first and second intermediate end flanges that can be secured together, to enable the upper bearing barrel and the lower extension column to be joined together.

In an embodiment, the inner end/surface of the operatively lower end of the bearing barrel comprises a first stepped flange to define a first stepped recess, comprising a first base flange portion fitted to the inner end/surface of the bearing barrel and an inwardly projecting first side flange portion extending inwardly away from the first base flange portion. Conveniently, the first bearing arrangement is accommodated within the first stepped recess, with the first bearing arrangement abutting against the inwardly projecting first side flange portion of the first stepped flange.

In an embodiment, the impeller is manufactured from abrasion and corrosion resistant materials and is the rotating component that moves and agitates the slurry fluid, the impeller being designed to handle higher solids content for particular use in slurry applications.

In an embodiment, the impeller is fitted with an expeller agitator or an axial flow inducer agitator, both of which are also manufactured from abrasion and corrosion resistant materials. The expeller agitator or axial flow inducer agitator is fitted to the end of the shaft in front of the impeller and can be used as an option in two various configurations, namely expeller agitation only (when using the expeller agitator) or induced axial flow agitation (when using the axial flow inducer agitator).

In an embodiment, the expeller self-flushing seal (SFS) arrangement comprises a steel water flinger located on the pump shaft; an expeller located on the shaft; and a grease pressurised double seal housing fastened with (CSK) screws to the upper bearing barrel. A threaded nut is used to fasten the water flinger and the expeller up to a shoulder on the shaft. Double seal housing spigots on the bearing landing are fastened by a stainless-steel CSK Allen key, thus sealing all contaminants from entering the first bearing arrangement.

In an embodiment, the operatively upper end of the bearing barrel is fitted with a second bearing housing comprising a second bearing arrangement to further facilitate the rotation of the pump shaft relative to the column. The second bearing housing comprises an upper end flange, and a second stepped flange proximate the inner end/surface of the operatively upper end of the bearing barrel. The second stepped flange define a second stepped recess and comprises a second base flange portion fitted to the inner end/surface of the bearing barrel and an inwardly projecting second side flange portion extending inwardly away from the second base flange portion. Conveniently, the second bearing arrangement is accommodated within the second stepped recess, with the second bearing arrangement abutting against the inwardly projecting second side flange portion of the second stepped flange.

In an embodiment, the operatively upper end of the bearing barrel is fitted with a second seal arrangement comprising a grease pressurised double seal housing fastened with CSK screws to the upper bearing barrel.

In embodiment, the pump shaft comprises an upper shaft portion that in use is accommodated within the upper bearing barrel of the column, the upper end of which defines a first upper recess to accommodate the second bearing arrangement, a second upper recess adjacent the first upper recess to accommodate the second seal arrangement, and the second threaded portion adjacent the second upper recess, with a protruding end tip of the pump shaft being connected to the drive means.

The lower end of the upper shaft portion defines a first lower recess to accommodate the first bearing arrangement, a second lower recess adjacent the first lower recess to accommodate the expeller self-flushing seal arrangement, and the first threaded portion adjacent the second lower recess.

In embodiment, the pump shaft comprises a lower shaft portion that in use is accommodated within the operatively lower extension column of the column. The lower end of the lower shaft portion comprises a third threaded portion, to which the impeller is fitted, with an impeller being secured to the end of the third threaded portion, so as to secure the impeller to the lower end of the lower shaft portion, and thus to the pump shaft itself.

In embodiment, the pump shaft takes the form of a cantilever pump shaft, with the first and second bearing arrangements being arranged to support the cantilever pump shaft that is connected to the mechanical driving mechanism. The cantilever pump shaft and column provide maximum load carrying capacity and ensure longevity of the first and second bearing arrangement. To assist with bearing overload, a stabilizing wet media seal bush and a shaft sleeve are provided to effectively seal and lubricate the pump shaft, thereby managing the small bypass flow of the various materials like mill scale, settled sludge, coal, gold, platinum, copper slurry, among many others.

The lower end of the lower shaft portion comprises a securing flange to which a wear plate hub disc is secured, the hub disc snugly and rotatingly accommodating the impeller.

An impeller casing is then secured, so as to enclose, the hub disc and the impeller, the impeller casing defining an inlet to receive the incoming slurry/sludge fluid, and an outlet through the agitated slurry/sludge fluid can exit. The impeller casing encloses the impeller into a concentric recess and is typically made from wear resistant and corrosive resistant materials to withstand abrasive and corrosive slurries.

The wear plate hub disc is made from wear resistant and corrosive resistant materials to withstand abrasive and corrosive slurries, and is arranged to accommodate the impeller casing wear ring and various sealing arrangements.

The hub disc utilises concentric spigots and through bolting to close off the impeller casing, which incorporates the recess for the vortex impeller and the wet media seal wear bush. This arrangement enables the pump to run dry without damaging it.

### BRIEF DESCRIPTION OF DRAWINGS

The objects of this invention and the manner of obtaining them, will become more apparent, and the invention itself will be better understood, by reference to the following description of embodiments of the invention taken in conjunction with the accompanying diagrammatic drawing, wherein:

FIG. 1 shows a cross-sectional side view of a vortex slurry pump according to the invention;

FIG. 2 shows an exploded side view of the vortex slurry pump shown in FIG. 1;

FIG. 3 shows a cross-sectional side view of a horizontal embodiment of the vortex slurry pump; and

FIG. 4 shows a side view of a belt-driven arrangement for the vortex slurry pump.

### DETAILED DESCRIPTION OF EXAMPLE EMBODIMENTS

The following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances and are a part of the present invention. Thus, the following description is provided as illustrative of the principles of the present invention and not a limitation thereof.

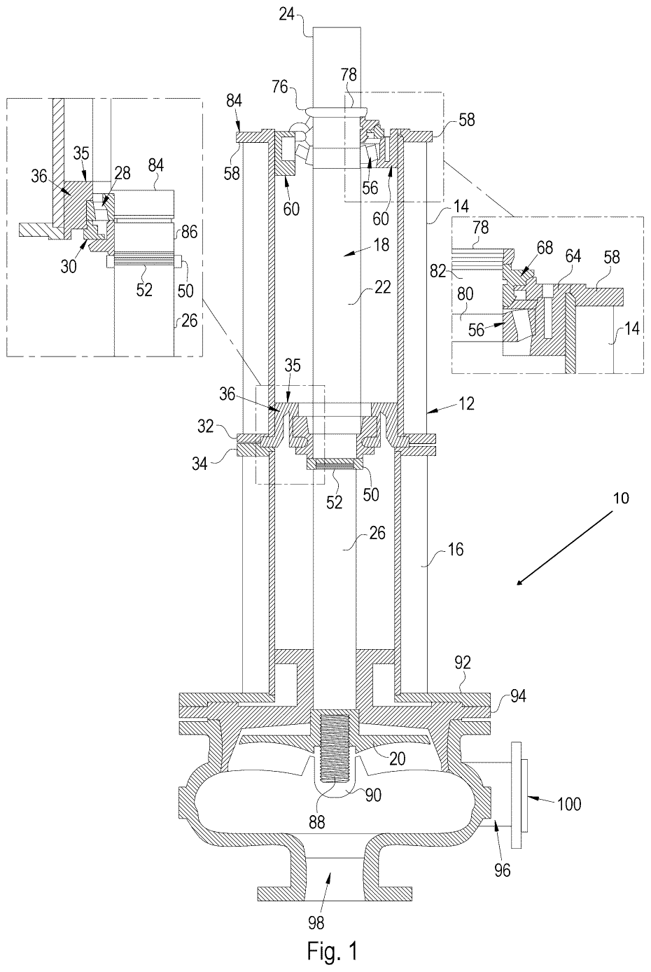

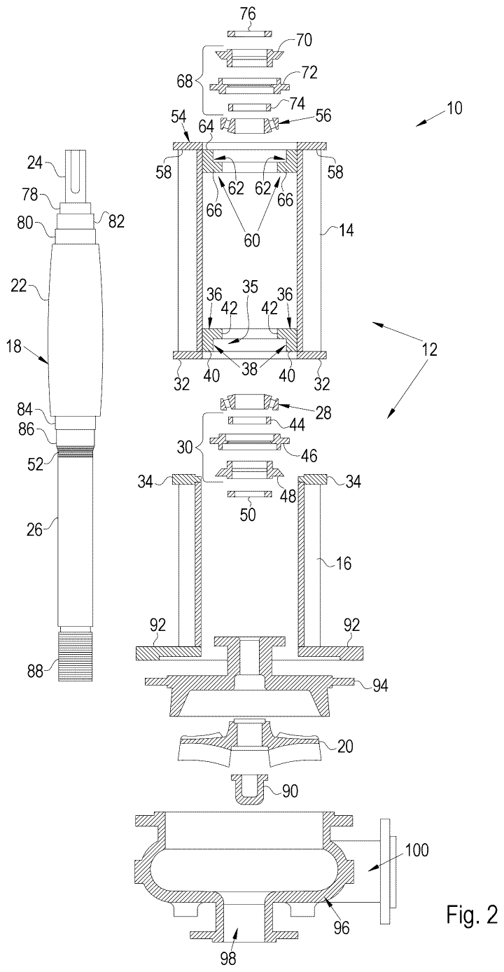

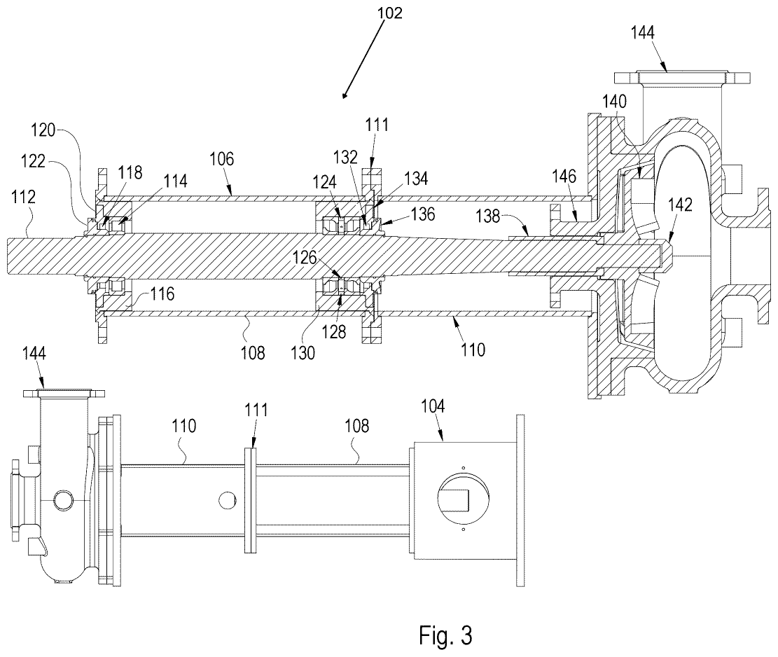

FIGS. 1 and 2 show a vortex slurry pump 10 for pumping slurry or sludge fluids or media. Although the vortex slurry pump 10 is shown in a vertical orientation, it may also be operated horizontally. FIG. 3 illustrates a horizontal embodiment of the vortex slurry pump, shown as horizontal pump assembly 102.

The vortex slurry pump 10 comprises a bearing column 12 comprising an operatively upper bearing barrel 14 and an operatively lower extension column 16. The operative upper end of the column 12 supports a drive means, such as an electric motor (not shown), via a coupling arrangement (or pulleys or belts), the bearing column 14 in use operating above the slurry fluid or media.

The vortex slurry pump 10 further includes a pump shaft or spindle 18 accommodated within the column 12, an upper end of the pump shaft 18 being connected to the drive means, and a lower end of the pump shaft 18 being fitted with an impeller 20. In particular, the pump shaft 18 comprises an upper shaft portion 22 that in use is accommodated within the upper bearing barrel 14 of the column 12, with a protruding end tip 24 of the pump shaft 18 being connected to the drive means. The pump shaft 18 further comprises a lower shaft portion 26 that in use is accommodated within the operatively lower extension column 16 of the column 12.

The slurry pump 10 defines a hydraulic wet end, with the impeller 20 being submerged within the slurry fluid in use and being arranged to agitate large concentrations of solids within the slurry fluid and keep them in suspension to prevent impeller blockage.

The vortex slurry pump 10 further includes a first bearing arrangement 28 to facilitate the rotation of the pump shaft 18 relative to the column 12.

An expeller self-flushing seal (SFS) arrangement 30 in the form of a hydro dynamic pressurised expeller (HDPE) SFS arrangement 30 is provided adjacent the first bearing arrangement 28, proximate an operatively lower end of the operatively upper bearing barrel 14, to prevent contaminants passing therethrough.

The operatively lower end of the upper bearing barrel 14 and the operatively upper end of the lower extension column 16 comprise first and second intermediate end flanges 32, 34 that can be secured together, to enable the upper bearing barrel 14 and the lower extension column 16 to be joined together (and to house the first bearing arrangement 28).

The first and second intermediate end flanges 32, 34, and in particular the end flange 34 forms part of a first bearing housing 35 to accommodate the first bearing arrangement 28.

In an embodiment, the inner end/surface of the operatively lower end of the upper bearing barrel 14 comprises a first stepped flange 36 (which is also part of the first bearing housing 35 to accommodate the first bearing arrangement 28) to define a first stepped recess 38. The first stepped flange 36 comprises a first base flange portion 40 fitted to the inner end/surface of the bearing barrel 14 and an inwardly projecting first side flange portion 42 extending inwardly away from the first base flange portion 40. Conveniently, the first bearing arrangement 28 is accommodated within the first stepped recess 38, with the first bearing arrangement 28 abutting against the inwardly projecting first side flange portion 42 of the first stepped flange 36.

In an embodiment, the impeller 20 is manufactured from abrasion and corrosion resistant materials and is the rotating component that moves and agitates the slurry fluid, the impeller 20 being designed to handle higher solids content for particular use in slurry applications.

In an embodiment, the impeller 20 is fitted with an expeller agitator or an axial flow inducer agitator, both of which are also manufactured from abrasion and corrosion resistant materials. The expeller agitator or axial flow inducer agitator is fitted to the end of the pump shaft 18 in front of the impeller 20 and can be used as an option in two various configurations, namely expeller agitation only (when using the expeller agitator) or induced axial flow agitation (when using the axial flow inducer agitator).

In an embodiment, as best shown in FIG. 2, the expeller self-flushing seal (SFS) arrangement 30 comprises a steel water flinger 44 located on the pump shaft 18; an expeller 46 located on the shaft 18; and a grease pressurised double seal housing 48 fastened with (CSK) screws to the upper bearing barrel 14. A threaded nut 50 is used to fasten the water flinger 44 and the expeller 46 up to a shoulder on the shaft 18. Double seal housing spigots on the bearing landing are fastened by a stainless steel CSK Allen key, thus sealing all contaminants from entering the first bearing arrangement 28.

The first bearing arrangement 28 and the expeller self-flushing seal arrangement 30 defines an inboard bearing and seal arrangement.

The nut 50 IS arranged to threadingly engage a corresponding first threaded portion 52 provided on the pump shaft 18. This securely engages the first bearing arrangement 28 and the expeller self-flushing seal arrangement 30 against the inwardly projecting first side flange portion 42 of the first stepped flange 36.

In general, the expeller type seal arrangement 30 is a dynamic sealing mechanism used in slurry pumps, such as the vortex slurry pump 10 of the present invention, to prevent leakage along the pump shaft 18. It involves the use of an expeller, which is a rotating component that functions similarly to an impeller. The key features of an expeller seal arrangement 30 are as follows:

### 1. Dynamic Seal

The expeller acts as a secondary impeller, creating a centrifugal force that directs the slurry away from the shaft, thereby forming a dynamic seal. This action helps to prevent the slurry from leaking out of the pump while it is in operation.

### 2. No Sealing Water Required

One of the advantages of an expeller seal is that it does not require external sealing water, which eliminates the risk of product dilution and reduces the overall cost of operation.

### 3. Zero Gland Leakage During Operation

When the pump is running, the expeller seal effectively prevents leakage, making it a reliable option for many applications.

### 4. Cost-effective

Compared to mechanical seals, expeller seals are generally more cost-effective and require less maintenance.

Overall, expeller seals are a practical solution for dynamic sealing in slurry pumps, particularly in applications where minimizing maintenance and operational costs is a priority.

In an embodiment, the operatively upper end of the bearing barrel 14 is fitted with a second bearing housing 54 comprising a second bearing arrangement 56 to further facilitate the rotation of the pump shaft 18 relative to the column 12. The second bearing housing 54 comprises an upper end flange 58, and a second stepped flange 60 proximate the inner end/surface of the operatively upper end of the upper bearing barrel 14.

The second stepped flange 60 defines a second stepped recess 62 and comprises a second base flange portion 64 fitted to the inner end/surface of the upper bearing barrel 14 and an inwardly projecting second side flange portion 66 extending inwardly away from the second base flange portion 64. Conveniently, the second bearing arrangement 56 is accommodated within the second stepped recess 62, with the second bearing arrangement 56 abutting against the inwardly projecting second side flange portion 66 of the second stepped flange 60.

In an embodiment, the operatively upper end of the upper bearing barrel 14 is fitted with a second seal arrangement 68 comprising a grease pressurised double seal housing 70, 72, 74 fastened with CSK screws to the upper bearing barrel 14.

The second bearing arrangement 56 and the second seal arrangement 68 defines an outboard bearing and seal arrangement.

In an embodiment, the second seal arrangement 68 further comprises a nut 76 arranged to threadingly engage a corresponding second threaded portion 78 provided on the pump shaft 18, so as to securely engage the second bearing arrangement 56 and the second seal arrangement 68 against the inwardly projecting second side flange portion 66 of the second stepped flange 60.

Turning back to the pump shaft 18, the upper end of the upper shaft portion 22 of the pump shaft 18 defines a first upper recess 80 to accommodate the second bearing arrangement 56, a second upper recess 82 adjacent the first upper recess 80 to accommodate the second seal arrangement 68, and the second threaded portion 78 adjacent the second upper recess 82, with a protruding end tip 24 of the pump shaft 18 being connected to the drive means.

The lower end of the upper shaft portion 22 defines a first lower recess 84 to accommodate the first bearing arrangement 28, a second lower recess 86 adjacent the first lower recess 84 to accommodate the expeller self-flushing seal arrangement 30, and the first threaded portion 52 adjacent the second lower recess 86.

The lower end of the lower shaft portion 26 of the pump shaft 18 comprises a third threaded portion 88, to which the impeller 20 is fitted, the impeller 20 being secured to the end of the third threaded portion 88 with a locknut 90, so as to secure the impeller 20 to the lower end of the lower shaft portion 26, and thus to the pump shaft 18 itself.

In embodiment, the pump shaft 18 takes the form of a cantilever pump shaft 18, with the first and second bearing arrangements 20, 56 being arranged to support the cantilever pump shaft 18 that is connected to the mechanical driving mechanism. The cantilever pump shaft 12 and column provide maximum load carrying capacity and ensure longevity of the first and second bearing arrangements 20, 56. To assist with bearing overload, a stabilizing wet media seal bush and a shaft sleeve are provided to effectively seal and lubricate the pump shaft 18, thereby managing the small bypass flow of the various materials like mill scale, settled sludge, coal, gold, platinum, copper slurry, among many others.

In the version using the expeller agitator or axial flow inducer agitator, these components are screwed onto the end of the shaft 18 in front of the impeller 20 and takes the place of the locknut 90.

The lower end of the lower shaft portion 26 comprises a securing flange 92 to which a wear plate hub disc 94 is secured, the hub disc 94 snugly and rotatingly accommodating the impeller 20. An impeller casing 96 (also called a volute) is then secured, so as to enclose, the hub disc 94 and the impeller 20, the impeller casing 96 defining an inlet 98 to receive the incoming slurry/sludge fluid, and an outlet 100 through the agitated slurry/sludge fluid can exit. The impeller casing 96 encloses the impeller 20 into a concentric recess and is typically made from wear resistant and corrosive resistant materials to withstand abrasive and corrosive slurries.

The wear plate hub disc 94 is made from wear resistant and corrosive resistant materials to withstand abrasive and corrosive slurries, and is arranged to accommodate the impeller casing wear ring and various sealing arrangements. The hub disc 94 utilises concentric spigots and through bolting to close off the impeller casing 96, which incorporates the recess for the vortex impeller 20 and the wet media seal wear bush. This arrangement enables the pump 10 to run dry without damaging it.

Referring to FIG. 3, a horizontal embodiment of the pump 102 is shown. This embodiment shares many functional principles with the vertical pump 10 but is configured for horizontal or angled installations. The pump 102 features a direct motor mount 104 for coupling with a drive means.

The pump 102 includes a bearing column 106, which in turn comprises a bearing housing 108 and a lower extension column 110, which are joined together by flanges 111. The bearing column 106 supports a pump shaft 112 having a cantilever design.

A key aspect of this embodiment is the bearing configuration. At the drive end (DE), a roller bearing 114 is used to support radial loads from the drive means. The roller bearing 114 is accommodated within a drive end bearing housing 116 and includes a seal 118 secured within an adjacent HDPE-S end cover 120. To protect the bearing 114, an HDPE-S expeller labyrinth seal arrangement 122 is fitted to the end cover 120, which is arranged to accommodate the shaft 112.

At the non-drive end (NDE), closer to the wet end, a set of two angular contact ball bearings 124 is provided, on either side of which is an inner bearing spacer 126 and an outer bearing spacer 128. The bearing set 124 is accommodated within a non-drive end bearing housing 130 and includes a seal 132 secured within an adjacent HDPE-S end cover 134.

To protect the bearing set 124 from the slurry, an HDPE-S expeller labyrinth seal arrangement 136 is fitted to the end cover 134, which is arranged to accommodate the shaft 112. This seal arrangement 136 functions similarly to the SFS arrangement 30 described above, using dynamic forces to prevent slurry ingress.

The shaft 112 is protected by a replaceable shaft sleeve 138 in the seal and wet end areas.

The NDE bearing set 124 is accurately spaced to handle both axial and radial loads, and critically, to manage the flex and dynamic loads inherent in a cantilevered shaft operating in a slurry environment. This arrangement is advantageous over traditional taper roller bearings as it does not require critical on-site end play adjustments, simplifying installation and maintenance.

The wet end of the horizontal pump 102 comprises a recessed impeller 140, which is secured to the shaft 112 with an impeller lock-nut 142. The impeller 140 rotates within a casing 144 (also known as a volute), which is enclosed by a hub disc 146. This construction is functionally equivalent to the wet end of the vertical pump, designed to create a vortex to pump slurries with large particles.

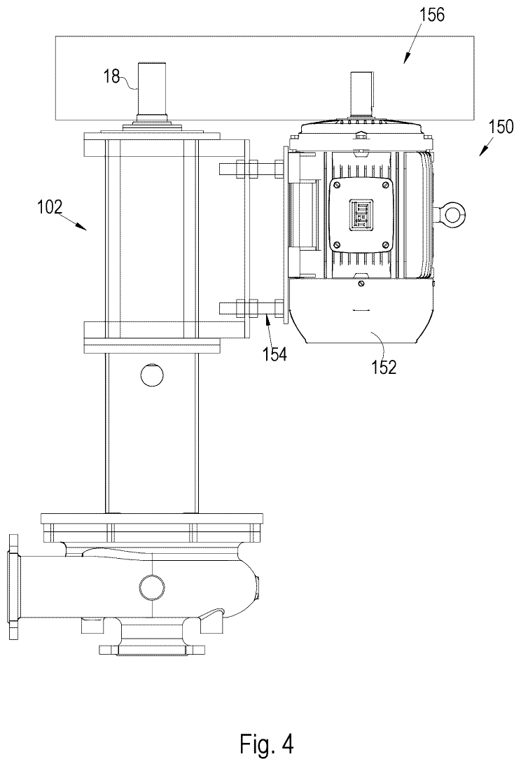

Referring to FIG. 4, an alternative belt-driven arrangement 150 is shown. This arrangement can be used with either the vertical pump 10 or a similarly adapted horizontal version. Instead of a direct-drive motor, the pump is driven by a motor 152 mounted on an adjustable side arrangement or motor mount 154. Power is transmitted to the pump shaft 18 via a V-belt and pulley system 156. This configuration allows for flexibility in motor selection and placement, and enables easy adjustment of pump speed by changing pulley sizes.

1. A vortex slurry pump, comprising: a column having a drive end and a wet end; a cantilever pump shaft rotatably supported within the column; a drive means operatively connected to the drive end of the pump shaft; a vortex impeller mounted to the wet end of the pump shaft, the impeller configured to operate submerged in a slurry; at least one bearing arrangement disposed within the column to support the cantilever pump shaft; and an expeller seal arrangement disposed between the vortex impeller and the at least one bearing arrangement, the expeller seal arrangement configured to generate a dynamic seal to prevent the slurry from entering the column and contacting the at least one bearing arrangement.

2. The vortex slurry pump of claim 1, wherein the at least one bearing arrangement comprises: a drive end (DE) bearing disposed proximate the drive end of the pump shaft; and a non-drive end (NDE) bearing set disposed proximate the wet end of the pump shaft, between the DE bearing and the expeller seal arrangement.

3. The vortex slurry pump of claim 2, wherein the DE bearing is a roller bearing and the NDE bearing set comprises at least one angular contact ball bearing.

4. The vortex slurry pump of claim 3, wherein the NDE bearing set comprises two angular contact ball bearings spaced apart to accommodate cantilever loads and shaft flex.

5. The vortex slurry pump of claim 1, wherein the expeller seal arrangement comprises a hydro dynamic pressurised expeller (HDPE) labyrinth seal.

6. The vortex slurry pump of claim 1, wherein the expeller seal arrangement comprises: a steel water flinger located on the pump shaft; an expeller located on the pump shaft adjacent the water flinger; and a grease pressurised double seal housing fastened to the column.

7. The vortex slurry pump of claim 1, wherein the pump is configured for vertical operation, and the column comprises an operatively upper bearing barrel and an operatively lower extension column.

8. The vortex slurry pump of claim 1, wherein the pump is configured for horizontal operation, and the column comprises a bearing housing.

9. The vortex slurry pump of claim 1, wherein the drive means is a direct-drive electric motor mounted to the drive end of the column.

10. The vortex slurry pump of claim 1, wherein the drive means comprises: an electric motor mounted on an adjustable mount adjacent to the column; and a belt and pulley system connecting the electric motor to the drive end of the pump shaft.

11. The vortex slurry pump of claim 1, further comprising a wet end assembly including the vortex impeller, a hub disc, and an impeller casing, wherein the wet end assembly is made from wear and corrosion resistant materials.

12. The vortex slurry pump of claim 11, wherein the wet end assembly is configured to permit the pump to run dry without damage.

13. The vortex slurry pump of claim 1, wherein the vortex impeller is further fitted with an agitator selected from the group consisting of an expeller agitator and an axial flow inducer agitator.

14. A vortex slurry pump, comprising:
a bearing housing having a drive end and a wet end;
a cantilever pump shaft rotatably supported within the bearing housing;
a roller bearing disposed at the drive end of the bearing housing to support the pump shaft;
a set of at least one angular contact ball bearing disposed at the wet end of the bearing housing to support the pump shaft;
a vortex impeller mounted to the pump shaft at the wet end; and
an expeller seal disposed along the pump shaft between the vortex impeller and the set of at least one angular contact ball bearing.

15. The vortex slurry pump of claim 14, wherein the pump is configured for operation in a horizontal orientation.
